(19) United States
(12) Patent Application Publication
(10) Pub. No.: US 2018/0203628 A1
(43) Pub. Date: Jul. 19, 2018

(54) METHOD, APPARATUS AND COMPUTER PROGRAM PRODUCT FOR EVALUATING DATA STORAGE SYSTEMS FOR ENERGY EFFICIENCY

(71) Applicant: EMC IP Holding Company LLC, Hopkinton, MA (US)

(72) Inventors: Roman Sergeevich Oderov, Saint-Petersbug (RU); Alexander Nikolaevich Alexeev, Saint-Petersbug (RU); Rustem Valeryevich Rafikov, Saint-Petersbug (RU)

(21) Appl. No.: 15/812,377

(22) PCT Filed: Jun. 30, 2015
(86) PCT No.: PCT/RU2015/000408

§ 371 Date: Nov. 17, 2017

(51) Int. Cl. G06F 3/06

(52) U.S. Cl. CPC G06F 3/0625; G06F 3/067; G06F 3/0655; G06F 3/0629

(57) ABSTRACT

There is disclosed herein techniques for use in energy-efficient certification of data storage systems. In one embodiment, the techniques comprise a method including a number of steps. The method comprises providing instructions to perform operations in connection with a data storage system, wherein the instructions comprise a set of data storage configuration parameters. The method also comprises receiving results in connection with performed operations, wherein the results comprise power consumed and performance of the data storage system. The method further comprises determining an optimum energy efficient data storage configuration based on the results. The optimum energy efficient data storage configuration is dependent on the power consumed and the performance of the data storage system.

### TECHNICAL FIELD

The invention relates generally to the field of information technology (IT). More specifically, the invention relates to evaluating data storage systems for energy efficiency.

### BACKGROUND OF THE INVENTION

For some time now, the task of addressing global warming has been gaining worldwide momentum. In an effort to curb global warming, many nations have begun instituting regulations on how much greenhouse gas an entity may emit. In some cases, these regulations stem from worldwide treaties that mandate a nation's maximum emissions. As such, a governing body within such a nation may provide an allocation of emissions (or amount of allowable emissions). In addition, in non-signatory nations, various governmental bodies have voluntarily instituted restrictions on greenhouse gas emissions.

Recently, several nations have expressed concern over the growing energy demands made by data centers. A single computing data center may include a large amount of computing equipment, including data storage systems, which consume large amounts of power. In addition to the power consumed by the computing equipment, the data center infrastructure (e.g., cooling, back-up power supplies, etc.) may account for a large proportion of the power consumed by the data center. Thus, the power consumed by a data center is significant. As energy costs rise, regional energy demand increases, and regulation of greenhouse gas emission increases, energy consumption and resource management may become a critical factor in managing a data center.

There are many initiatives aimed at reducing the amount of energy used in data centers (e.g., ENERGY STAR certification). This gives data center managers a tool with which they may better estimate energy use of their systems. Along those lines, storage equipment manufacturers have embarked on a campaign to produce “greener” machines that consume less energy.

However, in order to certify a particular system, the vendor may need to conduct a number of certification test runs, find major parameters and characteristics of the system under test (SUT) that affects energy efficiency, and then determine the optimal configuration. This procedure consists of many routines, such as: continuous system reconfiguration, benchmark running, logging and collecting of the results and the following post-processing. Moreover, an engineer involved in the certification may also perform some data analysis in order to narrow a set of potentially optimal configurations and to identify the best ones.

Thus, the procedure of a particular system certification is iterative, resource-intensive, and requires constant control by an engineer. The result is that the procedure is tiresome, error-prone, and time-consuming.

### SUMMARY OF THE INVENTION

There is disclosed a method, comprising: providing instructions to perform operations in connection with a data storage system, wherein the instructions comprise a set of data storage configuration parameters; receiving results in connection with performed operations, wherein the results comprise power consumed and performance of the data storage system; and based on the results, determining an optimum energy efficient data storage configuration, wherein the optimum energy efficient data storage configuration is dependent on the power consumed and the performance of the data storage system.

There is also disclosed an apparatus, comprising: memory; and control circuitry coupled to the memory, the memory storing instructions which, when carried out by the control circuitry, cause the control circuitry to: provide instructions to perform operations in connection with a data storage system, wherein the instructions comprise a set of data storage configuration parameters; receive results in connection with performed operations, wherein the results comprise power consumed and performance of the data storage system; and based on the results, determine an optimum energy efficient data storage configuration, wherein the optimum energy efficient data storage configuration is dependent on the power consumed and the performance of the data storage system.

There is further disclosed a computer program product having a non-transitory computer readable medium which stores a set of instructions, the set of instructions, when carried out by computerized circuitry, causing, the computerized circuitry to perform a method of providing instructions to perform operations in connection with a data storage system, wherein the instructions comprise a set of data storage configuration parameters; receiving results in connection with performed operations, wherein the results comprise power consumed and performance of the data storage system; and based on the results, determining an optimum energy efficient data storage configuration, wherein the optimum energy efficient data storage configuration is dependent on the power consumed and the performance of the data storage system.

### BRIEF DESCRIPTION OF THE DRAWINGS

The invention will be more clearly understood from the following description of preferred embodiments thereof which are given by way of examples only, with reference to the accompanying drawings, in which:

FIG. 1 is a block diagram of an electronic environment in accordance with the current disclosure.

FIG. 2 is a block diagram of data storage equipment illustrated in the electronic environment of FIG. 1.

FIG. 3 is a block diagram of a remote facility apparatus illustrated in the electronic environment of FIG. 1.

FIG. 4 is a flowchart of a procedure which is performed by the electronic environment of FIG. 1.

FIGS. 5(a) to (c) are graphs produced by the procedure of FIG. 4.

### DETAILED DESCRIPTION

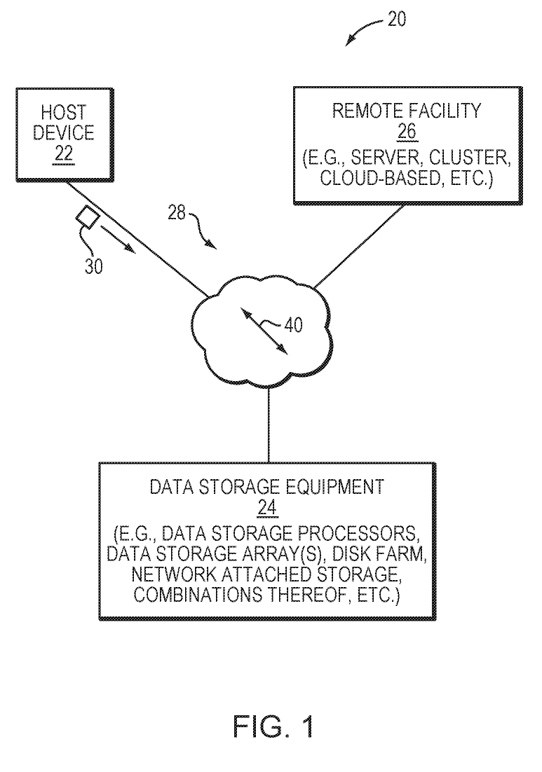

FIG. 1 is a block diagram of an electronic environment 20 which is suitable for use in evaluating data storage equipment for energy efficiency. The electronic environment 20 includes host device 22, data storage equipment 24, remote facility 26, and communications medium 28.

The host device 22 is constructed and arranged to send host input/output (IO) requests 30 to the data storage equipment 24. It should be appreciated that the host device 22 may represent one or more host devices constructed and arranged to send host IO requests. Also, the host device 22 is constructed and arranged to receive acknowledgements from the data storage equipment 24 in response to the IO requests 30. Further, the host device 22 is constructed and arranged to provide performance information (e.g., IOPS, etc.), among other information, to the remote facility 26 for facilitating evaluating data storage equipment for energy efficiency.

The data storage equipment 24 is constructed and arranged to perform host IO operations in response to the host IO requests 30. The data storage equipment 24 is further constructed and arranged to provide acknowledgments of the host IO operations to the host device 22. The data storage equipment 24 is still further constructed and arranged to provide results (e.g., operational information), among other information, to the remote facility 26. Examples of apparatus which are suitable for the data storage equipment 24 include data storage assemblies, storage processors, data storage arrays, disk farms, network attached storage devices, combinations thereof and various data storage components which are involved in storing data on behalf of host device 22.

The remote facility 26 is constructed and arranged to send configuration information to configure the data storage equipment 24 and workload information (e.g., workloads to be run) to the host device 22. The remote facility 26 is further configured and arranged to receive operational information from the data storage equipment 24 and performance information from the host device 22 after the workload is run by the host device 22 in connection with a number of data storage configuration(s) in connection with the data storage equipment 24. The remote facility 26 is still further configured and arranged to evaluate the operational and performance information by performing an analysis of this information in order to determine the optimal energy efficient data storage configuration. In these arrangements, the remote facility 26 may be in the form of a server, a cluster of devices, cloud-based, and so on.

The communications medium 28 is constructed and arranged to connect the various components of the electronic environment 20 together to enable these components to exchange electronic signals 40 (e.g., see the double arrow 40). At least a portion of the communications medium 28 is illustrated as a cloud to indicate that the communications medium 28 is capable of having a variety of different topologies including backbone, hub-and-spoke, loop, irregular, combinations thereof, and so on. Along these lines, the communications medium 28 may include copper-based data communications devices and cabling, fiber optic devices and cabling, wireless devices, combinations thereof, etc. Furthermore, the communications medium 28 is capable of supporting LAN-based communications, SAN-based communications, cellular communications, combinations thereof, etc.

During operation, the remote facility 26 provides the data storage equipment 24 with instructions including configuration information 79 to configure the data storage equipment 24. The remote facility 26 also provides host device 22 with workload information 78 including workloads to be run by the host device 22 in connection with the data storage equipment 24. After receiving the information, the host device 22 issues IO requests 30 that results in the data storage equipment 24 performing host IO operations on behalf of host device 22. Upon completion of the 10 operations, the data storage equipment 24 provides acknowledgments to the host device. The data storage equipment 24 also monitors operational information 72 in connection with the data storage equipment. The data storage equipment 24 stores the information 72 in a local database 42 that may include the power consumed in connection with the data storage system. The host device 22 on the other hand stores the performance information, such as the IOPS, in connection with performing the IO operations.

By way of further explanation, when the host device 22 generates an IO request 30 it sends the request to the storage system 24 for a particular data block. When the storage system 24 receives the request 30, it finds the necessary data block and sends it back to the host device 22. Thus, the host device 22 receives the requested data followed by a special “acknowledgement” message so that the host device 22 considers the IO request completed. So, based on IO request statistics, the host device 22 logs corresponding performance data: IOPS (the number of IO requests issued per second), MBPS (amount of megabytes of data received per second), response time (the average time of IO request processing: from the moment it was issued by the host till the moment the acknowledgement was received), and many other parameters.

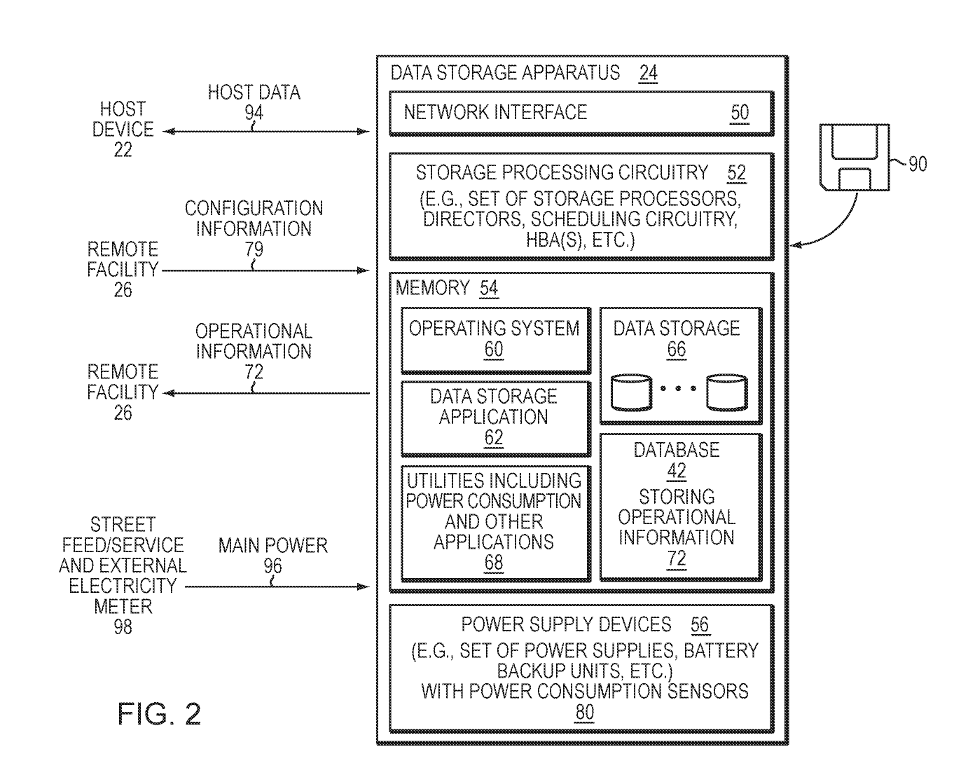

Next, the data storage equipment 24 sends the operational information 72 from the local database 42 to the remote facility 26 through the communications medium 28. Additionally, the host device 22 sends the performance information to the remote facility 26 through the communications medium 28. The remote facility 26 then evaluates this information to determine the optimum energy efficient data storage configuration of the data storage equipment 24. The remote facility 26 finally outputs a report 120 suitable for energy efficiency certification (e.g., ENERGY STAR certification). Further details will now be provided with reference to FIG. 2.

FIG. 2 is a block diagram of the data storage equipment 24 of the electronic environment 20 (also see FIG. 1). The data storage equipment 24 includes, among other things, a network interface 50, storage processing circuitry 52, memory 54, and power supply devices 56. Although the data storage equipment 24 is illustrated in FIG. 2 as having components which are tightly coupled, it should be understood that one or more of these data storage components may be disposed in a distributed manner (e.g., in a separate equipment cabinet or assembly, on a separate circuit board, etc.).

The network interface 50 is constructed and arranged to connect the data storage equipment 24 to the communications medium 28 (FIG. 1). Accordingly, the network interface 50 enables the data storage equipment 24 to communicate with the other components of the electronic environment 20. Such electronic communications may be copper-based or wireless (i.e., IP-based, SAN-based, cellular, Bluetooth, combinations thereof, and so on).

The storage processing circuitry 52 is constructed and arranged to operate in accordance with various software constructs stored in the memory 54. Along these lines, such circuitry 52 may be implemented in a variety of ways including via one or more processors (or cores) running specialized software, application specific ICs (ASICs), field programmable gate arrays (FPGAs) and associated programs, discrete components, analog circuits, other hardware circuitry, scheduling circuitry or timer circuits, host bus adapters (HBAs), and so on. In some arrangements, the storage processing circuitry 52 includes multiple storage processors or directors (e.g., blades) for fault tolerance and load balancing.

The memory 54 is intended to represent both volatile storage (e.g., DRAM, SRAM, etc.) and non-volatile storage (e.g., flash memory, magnetic disk drives, etc.). The memory 54 stores a variety of software constructs including an operating system 60, a data storage application 62, utilities 64, database 42 and data storage 66. The operating system 60 provides resource management. The data storage application 62 (which in some arrangements may be integrated with the operating system 60) performs the host IO operations on behalf of the host device 22. The utilities 64 includes a power consumption and other applications 68, which include instructions that direct the storage processing circuitry 52 to collect power consumption and other data from various components of the data storage equipment 24, while the data storage equipment 24 performs the host IO operations. The database 42 is constructed and arranged to store operational information 72 including, the power consumption data as well as other data.

The power supply devices 56 are provisioned with power consumption sensors 80 to collect at least some of the power consumption data. For example, the sensors 80 may measure or sample current levels and/or voltage levels routinely over the course of operation. The sensors 80 may also collect other power-related data such as operating temperature, loading (i.e., which devices are active), fan speeds, current throughput, current traffic levels, etc.

It should be understood that, in the context of one or more processors executing software, a computer program product 90 is capable of delivering all or portions of the software to the data storage equipment 24. The computer program product 90 has a non-transitory (or non-volatile) computer readable medium which stores a set of instructions which controls one or more operations of the data storage equipment 24. Examples of suitable computer readable storage media include tangible articles of manufacture and apparatus which store instructions in a non-volatile manner such as CD-ROM, flash memory, disk memory, tape memory, and the like.

It should be further understood that the data storage equipment 24 may include additional and other components as well. For example, the data storage equipment 24 may include a console or user interface which is constructed and arranged to receive input from a user and provide output to the user, etc.

During operation, the data storage equipment 24 receives, and provides host data 94 to the host devices 22 (see the double arrow in FIG. 2). Additionally, the data storage equipment 24 receives instructions including configuration information 79 from the remote facility 26. Furthermore, the data storage equipment 24 collects and sends the operational information 72 to the remote facility 26 for evaluation. Moreover, the data storage equipment 24 consumes main power 96 from a street feed/service and external electricity meter 98.

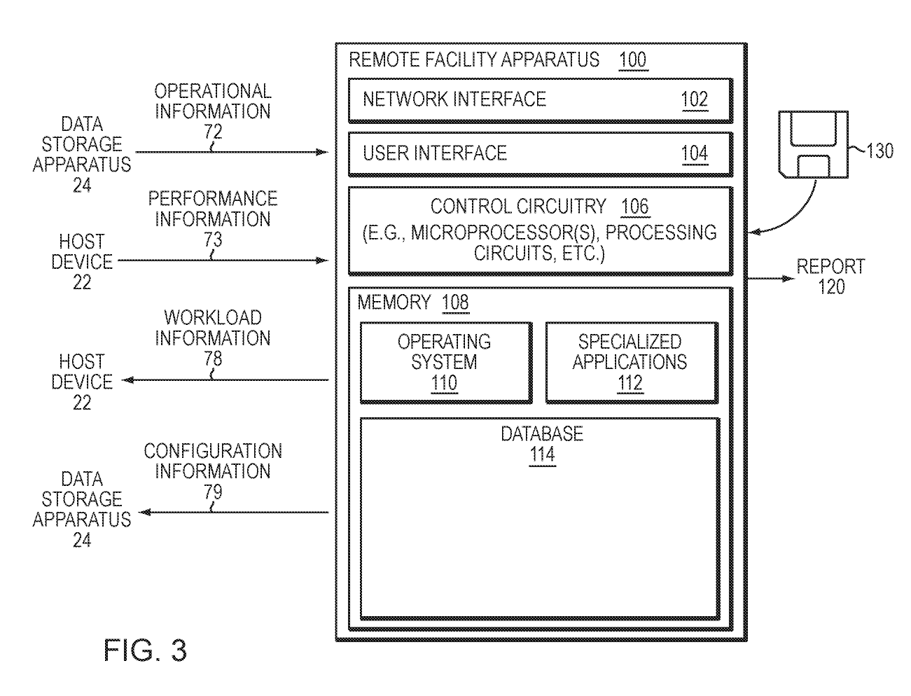

It should be appreciated that, although the external electricity meter 98 may provide some insight as to the power consumption pattern of the data storage equipment 24, such insight is limited (e.g., due to poor granularity, lack of control/understanding, etc.). In particular, other equipment connected to the external electricity meter 98 may skew or corrupt the ability of the data from the external electricity meter 98 to identify power consumption efficiency of the data storage equipment 24. Moreover, there is no convenient mechanism that enables the operator to easily correlate readings from the external electricity meter 98 with any operating schedule or events of the data storage equipment 24. Further details will now be provided with reference to FIG. 3.

FIG. 3 is a block diagram of a remote facility apparatus 100 which is suitable for use as the remote facility 26 or a portion thereof (also see FIG. 1). In particular, the remote facility apparatus 100 receives operational information 72 from the data storage equipment 24 and performance information 73 from the host device suitable for determining the optimum energy efficient data storage configuration of the data storage equipment 24. As shown in FIG. 3, the remote facility apparatus 100 includes, among other things, a network interface 102, a user interface 104, control circuitry 106, and memory 108.

The network interface 102 is constructed and arranged to connect the remote facility apparatus 100 to the communications medium 28 (FIG. 1). Accordingly, the network interface 102 enables the remote facility apparatus 100 to communicate with the other components of the electronic environment 20. Such electronic communications may be copper-based or wireless (i.e., IP-based, SAN-based, cellular, Bluetooth, combinations thereof, and so on).

The user interface 104 is constructed and arranged to receive input from one or more users and provide output to the one or more users. In some arrangements, the user interface may take the form of a set of consoles, terminals, and/or user/client workstations each having a standard keyboard, pointing device (e.g., mouse) and display.

The control circuitry 106 is constructed and arranged to operate in accordance with various software constructs stored in the memory 108. Along these lines, such control circuitry 106 may be implemented in a variety of ways including via one or more processors (or cores) running specialized software, application specific ICs (ASICs) field programmable gate arrays (FPGAs) and associated programs, and so on. In some arrangements, the control circuitry 106 includes multiple microprocessors for fault tolerance and load balancing.

The memory 108 is intended to represent both volatile storage (e.g., DRAM, SRAM, etc.) and non-volatile storage (e.g., flash memory, magnetic disk drives, etc.). The memory 108 stores a variety of software constructs including an operating system 110, specialized applications 112, and a database 114. The operating system 110 provides resource management. The specialized applications 112 receive the operational and performance information (72, 73) and store same in the database 114.

The specialized applications 112 further retrieve the information (72, 73) from the database 114 to generate a report 120. In particular, the specialized applications 112 process the information (72, 73) to generate specialized reports 120 for use in certification (e.g., ENERGY STAR certification). The information in these reports 120 provide precise results which are specific to particular data storage equipment 24, i.e., fine granularity.

It should be understood that, in the context of one or more processors executing software, a computer program product 130 is capable of delivering all or portions of the software to the remote facility apparatus 100. The computer program product 130 has a non-transitory (or non-volatile) computer readable medium which stores a set of instructions which controls one or more operations of the remote facility apparatus 100. Examples of suitable computer readable storage media include tangible articles of manufacture and apparatus which store instructions in a non-volatile manner such as CD-ROM, flash memory, disk memory, tape memory, and the like.

One will appreciate that performing analytics at the remote facility apparatus 100 removes the burden from the data storage equipment 24. It should be understood that the remote facility apparatus 100 is illustrated in FIG. 3 as having components which are tightly coupled by way of example only. In other arrangements, one or more of these components may be disposed in a distributed manner (e.g., in a distributed manner, within a server farm or cluster of devices, in the cloud, etc.).

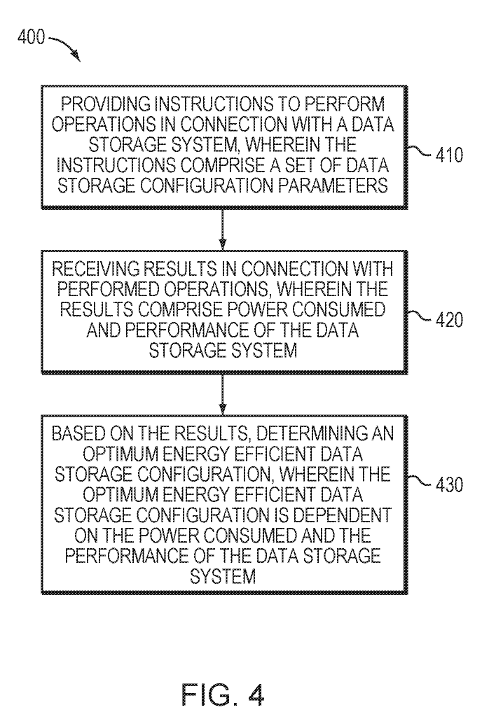

Referring to FIG. 4, there is illustrated a flowchart of a procedure which is performed by the electronic environment of FIG. 1. In the flow diagram, the operations are summarized in individual blocks. The operations may be performed in hardware, or as processor-executable instructions that may be executed by a processor. Furthermore, the method 400 may, but need not necessarily, be implemented in the environment of FIG. 1.

At step 410, the method comprises providing instructions to perform operations in connection with a data storage system. The instructions comprise a set of data storage configuration parameters. Further, the instructions may comprise workloads to be performed by host device. At step 420, the method comprises receiving results in connection with performed operations. The results comprise power consumed and performance of the data storage system. At step 430, the method comprises determining, based on the results, an optimum energy efficient data storage configuration which is dependent on the power consumed and the performance of the data storage system.

The remote facility apparatus 100 is configured to perform the above steps. The apparatus 100 is suitable for managing the whole certification process. In one particular embodiment, it may be deployed in a cloud environment (e.g., Pivotal CF) and can be easily accessed via a web-interface.

As discussed above, it should be appreciated that the apparatus 100 may comprise several functional modules and features which may be responsible for certain phases of the certification process. For example, the modules and features may include:

### System Configuration Module

This particular module may facilitate centralized, easy-to-use management of a data storage system under test (SUT) and hosts, as follows:
SUT-side functionality: host registration, creation/deletion of LUNs, Pools, RAID-groups, storage groups, etc.
Host-side functionality: installation and running necessary instruments and tools, simplified process of VdBench I/O generator set up either in automatic way or manually via a light-weight web-interface, etc.
The module may also facilitate HW configuration request generation.

By using the system configuration module, the process of SUT and host configuration becomes faster, easier and fully automated. Possible errors that existed previously due to the human factor may be eradicated.

### Test Module

This particular module may facilitate or initiate automated running of tests and logging necessary system parameters (e.g., trace files, CPU utilization, power consumption, etc.).

### Storage Subsystem

This particular feature facilitates storing the results to a permanent repository after a test run for further use.

### Post-Processing Module

This particular module may facilitate converting data to a suitable format for further analysis as all the data is stored in specific formats. The data may need to be parsed, converted to a unique time reference frame, merged, etc.

### Data Analysis Module

This particular module may facilitate providing an automated analysis of test results, calculated local (within the current certification run) optimal points and determine if they can be enhanced (e.g., by means of configuration parameter adjustment, such as thread or LUN count). If they can, the application reconfigures SUT and hosts in order to meet new requirements and the certification cycle repeats one more time. If it is impossible to obtain better optimal numbers, the application tries to determine causes of this limitation and report them to user/engineer (e.g. performance can be bounded by disk throughput or CPU saturation). Thus, after sequential iterations of test, the process converges in optimal points and energy efficiency ratio can be calculated.

### Prediction and History-Based Modeling Module

This particular module may facilitate providing system behavior modeling for those SUT configurations which are not tested and optimal point prediction with certain accuracy. Various machine learning techniques as well as history-based extrapolating algorithms can be used.

### Module for Report Generation

This particular module may facilitate providing a customizable report in any available format (e.g., Excel file, PDF, etc.). The report can consist of charts, diagrams (e.g. Performance vs. I/O thread count vs. drive count), summary tables, average values, information about SUT configuration, etc. Also, an official Energy Star report can be automatically generated.

### Certification Management Module

This particular module may facilitate managing the overall certification process and manage all other components of the cloud-based tool chain. It may handle requests for certification of particular systems and provides all necessary information including reports mentioned above. It may also allow conducting certification in a “batch” mode in a full-automatic way if there are no severe errors.

Advantageously, a cloud-based framework can significantly simplify and almost fully automate ENERGY STAR certification process. A user will receive only notifications about a successful or erroneous completion of a particular phase of the certification. If any problem occurs, the user will have the option to solve it manually or to address it to a special support service.

Furthermore, the certification process may be simplified with the help of an easy-to-use web-application. Human error probability is minimized due to hidden configuration details. An employee doesn't need to have special skills in systems administration, etc. Standardization of the certification process becomes possible. Also, regression testing can be performed, i.e. new software and hardware configurations can be tested to make sure if their energy efficiency characteristics improve or become worse.

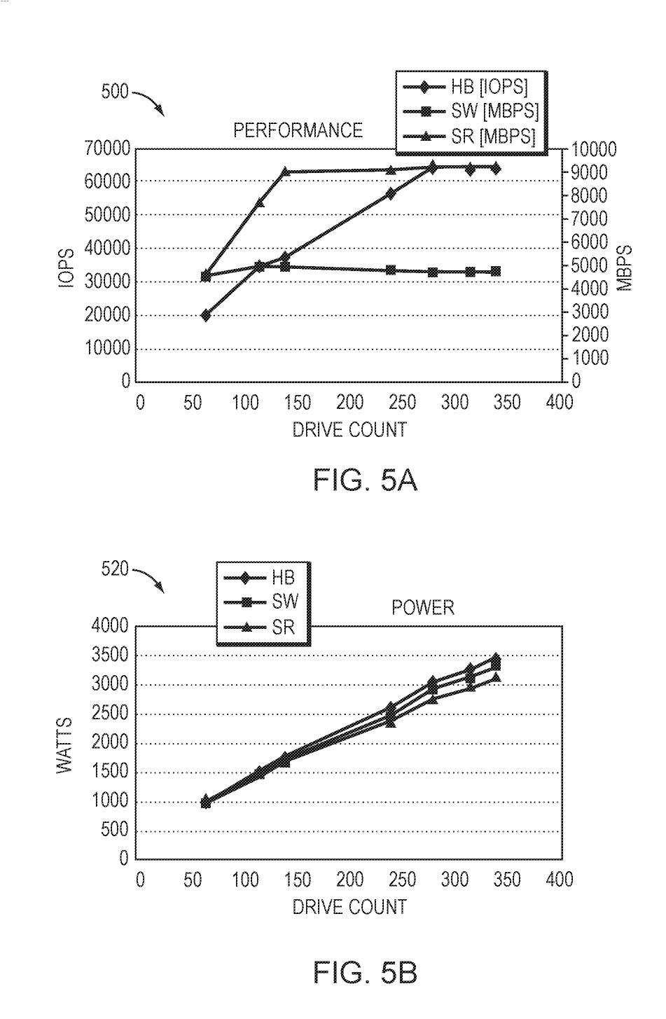

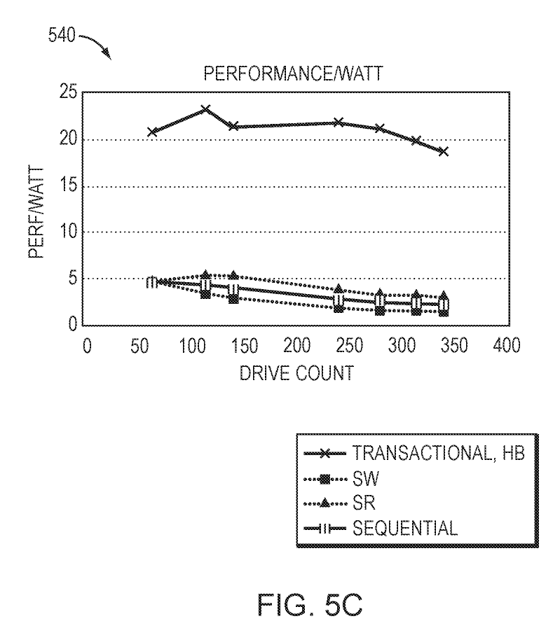

FIGS. 5(a) to (c) are graphs produced by the procedure of FIG. 4. These graphs may be included as part of the report 120. FIG. 5(a) illustrates a graph 500 showing performance after testing the data storage system 24. As can be seen, the performance is represented by IOPS and MBPS on the y-axes and the number of drives on the x-axis. FIG. 5(b) illustrates a graph 520 showing power consumed during the test for these particular configurations. The power is represented by Watts consumed by the data storage system 24. The x-axis comprises the number of drives in the system 24 under test. FIG. 5(c) illustrates a graph 540 showing energy efficiency (i.e. perf/watt) on the y-axis and the number of drives on the x-axis. The graphs comprise the outcome for Hot Band (i.e., a random access cache-positive workload) and SW and SR (i.e., Sequential Write and Sequential Read, respectively—sequential access write/read workloads).

Assume the certification process is for a VNX5600, manufactured and provided by EMC Corp, of Hopkinton, Mass. In this embodiment, several drive setups are chosen for tests: 65, 115, 140, 240, 280, 315 and 340 drives. As will be seen in the graphs, the 115 drive configuration is the optimal setup for energy efficiency [i.e. Perf/Watt] ratio in connection with random workloads. For example, the performance for the 280 drive configuration was bound with CPU as well as for 315 and 340. But power linearly increases after inserting additional disk enclosures. Thus, Perf/Watt ratio decreases. The 65 drive configuration is the optimal setup for the sequential workloads.

Additionally, in another embodiment, assume it is necessary to certify a product line. The process becomes very simple. An engineer may post a request for certification of a set of products (e.g. {VNX5400, VNX5600, VNX5800}). The engineer may choose one of two ways: to model energy efficiency ratio based on existing data or to conduct a full certification cycle.

Then, depending on the decision, the framework may automatically perform necessary operations and return the result. If there is sufficient data for modeling, the corresponding module may process these data and return an optimal point with certain accuracy. If there's lack of data and/or a real test run needed, it may be necessary to conduct the whole certification cycle.

The cloud-based tool sets up an initial configuration (it may request a HW reconfiguration, create LUNs and Pools, etc.). Then testing, logging and result collecting take place. After the testing finishes, the data is post-processed and analyzed. If a local optimal point can be improved, a certification test is repeated with adjusted parameters. After obtaining optimal results, the framework can produce a customizable report and move forward to the next product, being certified. Thus, an engineer doesn't participate in testing process; the new procedure takes less time, effectiveness of resource utilization increases.

While various embodiments of the invention have been particularly shown and described, it will be understood by those skilled in the art that various changes in form and details may be made therein without departing from the spirit and scope of the invention as defined by the appended claims.

What is claimed is:

1. A method, comprising:
providing instructions to perform operations in connection with a data storage system, wherein the instructions comprise a set of data storage configuration parameters;
receiving results in connection with performed operations, wherein the results comprise power consumed and performance of the data storage system; and
based on the results, determining an optimum energy efficient data storage configuration, wherein the optimum energy efficient data storage configuration is dependent on, the power consumed and the performance of the data storage system.

2. The method as claimed in claim 1, wherein the set of data storage configuration parameters relate to the data storage system; and wherein
providing instructions to perform operations in connection with a data storage system comprises:
providing instructions to the data storage system to configure in accordance with the set of data storage configuration parameters.

3. The method as claimed in claim 1, wherein the instructions comprise a workload to be run by a host device in connection with the data storage system; and wherein
providing instructions to perform operations in connection with a data storage system comprises:
providing the workload to the host device to run the workload in connection with the data storage system.

4. The method as claimed in claim 1, wherein the results are received from the host device and the data storage system; and wherein
receiving results in connection with performed operations comprises:
receiving, from the data storage system, power information relating to the power consumed by the data storage system during host-initiated IO operations performed by the data storage system; and
receiving, from the host device, performance information relating to host-initiated IO operations performed by the data storage system.

5. The method as claimed in claim 1, wherein the operations relate to at least one of random and sequential workloads to be performed in connection with the data storage system; and wherein
determining an optimum energy efficient data storage configuration comprises:
performing an analysis in connection with the results associated with at least one of random and sequential workloads performed in connection with the data storage system; and
determining the optimum energy efficient data storage configuration associated with at least one of random and sequential workloads performed in connection with the data storage system.

6. An apparatus, comprising:
memory; and
control circuitry coupled to the memory, the memory storing instructions which, when carried out by the control circuitry, cause the control circuitry to:
provide instructions to perform operations in connection with a data storage system, wherein the instructions comprise a set of data storage configuration parameters;
receive results in connection with performed operations, wherein the results comprise power consumed and performance of the data storage system; and
based on the results, determine an optimum energy efficient data storage configuration, wherein the optimum energy efficient data storage configuration is dependent on the power consumed and the performance of the data storage system.

7. The apparatus as claimed in claim 6, wherein the set of data storage configuration parameters relate to the data storage system; and wherein
providing instructions to perform operations in connection with a data storage system comprises:
providing instructions to the data storage system to configure in accordance with the set of data storage configuration parameters.

8. The apparatus as claimed in claim 6, wherein the instructions comprise a workload to be run by a host device in connection with the data storage system; and wherein
providing instructions to perform operations in connection with a data storage system comprises:
providing the workload to the host device to run the workload in connection with the data storage system.

9. The apparatus as claimed in claim 6, wherein the results are received from the host device and the data storage system; and wherein
receiving results in connection with performed operations comprises:
receiving, from the data storage system, power information relating to the power consumed by the data storage system during host-initiated IO operations performed by the data storage system; and
receiving, from the host device, performance information relating, to host-initiated IO operations performed by the data storage system.

10. The apparatus as claimed in claim 6, wherein the operations relate to at least one of random and sequential workloads to be performed in connection with the data storage system; and wherein
determining an optimum energy efficient data storage configuration comprises:
performing an analysis in connection with the results associated with at least one of random and sequential workloads performed in connection with the data storage system; and
determining the optimum energy efficient data storage configuration associated with at least one of random and sequential workloads performed in connection with the data storage system.

11. A computer program product having, a non-transitory computer readable medium which stores a set of instructions, the set of instructions, when carried out by computerized circuitry, causing the computerized circuitry to perform a method of:
providing instructions to perform operations in connection with a data storage system, wherein the instructions comprise a set of data storage configuration parameters;
receiving results in connection with performed operations, wherein the results comprise power consumed and performance of the data storage system; and
based on the results, determining an optimum energy efficient data storage configuration, wherein the optimum energy efficient data storage configuration is dependent on the power consumed and the performance of the data storage system.

12. The computer program product as claimed in claim 11, wherein the set of data storage configuration parameters relate to the data storage system; and wherein
providing instructions to perform operations in connection with a data storage system comprises:
providing instructions to the data storage system to configure in accordance with the set of data storage configuration parameters.

13. The computer program product as claimed in claim 11, wherein the instructions comprise a workload to be run by a host device in connection with the data storage system; and wherein
providing instructions to perform operations in connection with a data storage system comprises:
providing the workload to the host device to run the workload in connection with the data storage system.

14. The computer program product as claimed in claim 11, wherein the results are received from the host device and the data storage system; and wherein
receiving results in connection with performed operations comprises:
receiving, from the data storage system, power information relating to the power consumed by the data storage system during host-initiated IO operations performed by the data storage system; and
receiving, from the host device, performance information relating to host-initiated IO operations performed by the data storage system.

15. The computer program product as claimed in claim 11, wherein the operations, relate to at least one of random and sequential workloads to be performed in connection with the data storage system; and wherein
determining an optimum energy efficient data storage configuration comprises:
performing an analysis in connection with the results associated with at, least one of random and sequential workloads performed in connection with the data storage system; and
determining the optimum energy efficient data storage configuration associated with at least one of random and sequential workloads performed in connection with the data storage system.
